(19) United States
(12) Patent Application Publication
(10) Pub. No.: US 2016/0350711 A1
(43) Pub. Date: Dec. 1, 2016

(54) ALTERNATIVE DELIVERY DESTINATION SYSTEM

(71) Applicant: Accenture Global Services Limited, Dublin (IE)

(72) Inventor: Vivien Tsao, Palo Alto, CA (US)

(21) Appl. No.: 14/815,414

(22) Filed: Jul. 31, 2015

Related U.S. Application Data
(60) Provisional application No. 62/169,256, filed on Jun. 1, 2015.

(51) Int. Cl. G06Q 10/08; G06Q 50/30; H04L 29/08

(52) U.S. Cl. CPC G06Q 10/0833; H04L 67/18; G06Q 50/30

(57) ABSTRACT

The present disclosure relates to a method that includes determining a location of a delivery agent associated with a delivery route. The method includes determining that the location has satisfied one or more proximity criteria, and in response to determining that the location has satisfied the one or more proximity criteria, the method provides an initial alternative delivery user interface to a device of a user. The alternative delivery user interface includes a control for initiating an alternative delivery destination option. An indication is received that the control for initiating the alternative delivery destination option has been selected, and one or more candidate alternative delivery destinations are determined based at least on the location of the delivery agent and a location associated with the user.

### CROSS-REFERENCE TO RELATED APPLICATION

This application claims the benefit of U.S. Provisional Patent Application No. 62/169,256, filed Jun. 1, 2015, which is hereby incorporated by reference in its entirety.

### TECHNICAL FIELD

This specification generally relates to object tracking.

### BACKGROUND

Package delivery, or parcel delivery, refers to the delivery of shipping containers, parcels, or high value mail. Package delivery services are provided by most postal systems, as well as by private package delivery services.

### SUMMARY

The present disclosure relates to the delivery of packages. An alternative delivery destination for a package may be suggested to the package's recipient. The alternative delivery destination may be a location where the recipient may meet the agent on route to deliver the package. Multiple candidate alternative delivery destinations may be presented to the recipient, and the recipient may select one of the candidate alternative delivery destinations using a mobile device. The recipient may also receive a notification that the delivery agent is within some proximity to the original delivery destination.

In one aspect, a method includes determining a location of a delivery agent that is associated with a delivery route having one or more delivery destinations and determining that the location has satisfied one or more proximity criteria. The method also includes, in response to determining that the location has satisfied the one or more proximity criteria, providing an initial alternative delivery user interface to a device of a user that is associated with a particular delivery destination on the route, wherein the alternative delivery user interface includes a control for initiating an alternative delivery destination option. The method also includes receiving an indication that the control for initiating the alternative delivery destination option has been selected, determining one or more candidate alternative delivery destinations based at least on the location of the delivery agent and a location associated with the user, and providing an additional alternative delivery user interface to the device of the user, wherein the additional alternative delivery user interface includes one or more controls for selecting one or more corresponding alternative delivery destinations. The method also includes receiving an indication that a particular control corresponding to a particular alternative delivery destination has been selected and, in response to receiving an indication that a particular control corresponding to a particular alternative delivery destination has been selected, transmitting, to the delivery agent, an indication of the selected, particular alternative delivery destination.

Implementations may include one or more of the following features. The proximity criteria may include one or more of a proximity to the user, a proximity to a delivery destination, a proximity to a delivery route, a location within a designated geographic region, an estimated travel time associated with the user, or an estimated travel time associated with the delivery agent. The method may include in response to receiving an indication that a particular control corresponding to a particular alternative delivery destination has been selected, determining an updated delivery route. The method may include transmitting, to the delivery agent, the updated delivery route. Determining an updated delivery route may include excluding the particular delivery destination from the delivery route. The method may include in response to receiving an indication that a particular control corresponding to a particular alternative delivery destination has been selected, determining a delivery agent wait time associated with the particular alternative delivery destination.

Other implementations of these and other aspects include corresponding systems, apparatus, and computer programs, configured to perform the actions of the methods, encoded on computer storage devices. A system of one or more computers can be so configured by virtue of software, firmware, hardware, or a combination of them installed on the system that in operation cause the system to perform the actions. One or more computer programs can be so configured by virtue of having instructions that, when executed by data processing apparatus, cause the apparatus to perform the actions.

Advantageous implementations may include one or more of the following features. The techniques described may allow a package recipient to interact with the delivery process. User interaction may provide a degree of flexibility in the delivery process. The techniques may allow the delivery of a package to be more convenient for a recipient and/or a delivery agent. The techniques may reduce overall waiting time for a recipient. The techniques may allow minor changes to a previously planned delivery route to minimize affecting other recipients on that route. The techniques may provide notifications to keep the recipient informed of the location and delivery schedule of the delivery agent.

The details of one or more implementations of the subject matter described in this specification are set forth in the accompanying drawings and the description below. Other potential features, aspects, and advantages of the subject matter will become apparent from the description, the drawings, and the claims.

### BRIEF DESCRIPTION OF THE DRAWINGS

FIG. 1A illustrates an example alternative delivery system.

FIGS. 1B-1D illustrate example user interaction displays on a mobile device.

FIG. 1E illustrates an example notification display for a delivery agent.

FIGS. 2A-B show example interfaces for a user's mobile device.

FIG. 3 illustrates a block diagram of an example alternative delivery system.

FIG. 4 is a flow chart illustrating an example process for providing an alternative delivery destination.

FIG. 5 shows an example of a computing device and an example of a mobile computing device that can be used to implement the techniques described here.

FIG. 6 is a block diagram of an example delivery system that can be used to implement the techniques described here.

Like reference numbers and designations in the various drawings indicate like elements.

### DETAILED DESCRIPTION

Typically, package delivery routes are planned to minimize delivery times and fuel cost. However, the predetermined delivery destination is not always the most efficient location for a recipient to receive a package. For example, in some cases, a recipient is not present to receive the package when the delivery agent arrives at the destination. In some cases, the recipient may be closer to the delivery agent than to the delivery destination, and thus delivering the package to the predetermined destination may waste time and fuel. As another example, in some cases the recipient may be on his or her way to the delivery destination, but will not arrive in time to receive the package. In some of these cases, it may be more convenient and efficient for the recipient to meet the delivery agent and receive the package than to receive the package at the original delivery destination.

Accordingly, the present disclosure describes techniques determining and arranging an alternative delivery destination for a package that is already in the process of being delivered. One example technique notifies a package recipient that a package is nearing the delivery destination. The package recipient may be a user of a mobile device, and the notification may be made through an interface on the mobile device. The interface may provide the option of an alternative delivery destination to the user. If selected, an alternative delivery destination can be provided to the user as a location for the user to meet the delivery agent and receive the package. The alternative delivery destination may be provided to the delivery agent, and the delivery agent may also be provided with a wait time to wait at the alternative delivery destination for the user to arrive and receive the package.

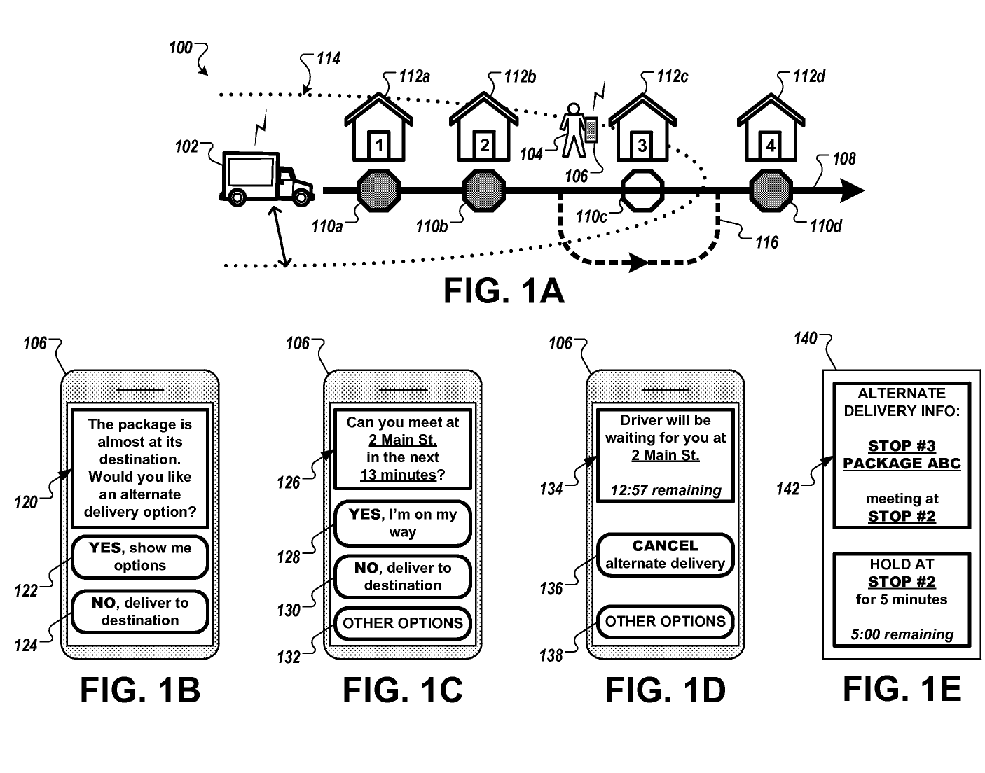

FIG. 1A illustrates an example alternative delivery system 100, FIGS. 1B-1D illustrate example user interaction displays 120, 126, 134 on a mobile device 106, and FIG. 1E illustrates an example notification display 142 for a delivery agent 102. As shown in FIG. 1A, a delivery agent 102 delivers packages to multiple delivery destinations 112a-d along a predetermined delivery route 108. The delivery agent 102 may be, for example, a delivery truck, delivery carrier, or other agent. The delivery route 108 includes several delivery stops 110a-d, each respectively associated with delivery destinations 112a-d. A delivery stop may be a location on a route associated with one or more delivery destinations. For example, a delivery destination may be a recipient's house, and the associated delivery stop may be a location on the street in front of the house where a delivery stuck may park to deliver the package to the house. Other example destinations, stops, and associations are possible.

User 104 is a recipient of a package associated with delivery destination 112c and delivery stop 110c. The user 104 uses mobile device 106, which may be a smartphone, laptop, tablet computer, music player, wearable computer, or other type of computing device. The mobile device 106 may provide to the user 104 an interface including controls, notifications, interactive displays, a graphical user interface, images, or other displays of information. In some cases, the user 104 may interact with the mobile device 106 via a voice interface. The mobile device 106 may run an application that enables interaction between the user 104 and the delivery agent 102. In particular, the interaction may provide an alternative delivery option, as described below.

The alternative delivery system 100 includes one or more associated proximity criteria. The proximity criteria may indicate a proximity relative to a location of the delivery agent 102. The proximity criteria may include, for example, a proximity to the user 104, a proximity to a delivery destination 112a-d, and/or a proximity to a delivery route 108. The proximity criteria may also include a designated geographic region such as a geofence, ZIP code, street, city, and/or other designation. The proximity criteria may also include an estimated travel time associated with the user 104 and/or an estimated travel time associated with the delivery agent 102. FIG. 1A shows an example proximity criterion 114 as a physical distance from the delivery agent 102, though in other implementations the proximity criterion may be based on other criteria, e.g., time criteria, or number of stops criteria.

If one or more proximity criteria are satisfied, an initial alternative delivery interface 120 may be provided to the mobile device 106 of the user 104. For example, a distance-based proximity criterion may be satisfied if the delivery agent 102 is within a predefined distance of the delivery destination 112c associated with the user 104. As another example, a time-based proximity criterion can be satisfied if the delivery for the delivery destination 112c is estimated to occur within a predefined duration of time. In other cases, other proximity criteria may be satisfied differently.

FIG. 1B shows an example initial alternative delivery interface 120 on a mobile device 106. The initial interface 120 is presented to the user 104 if proximity criteria is satisfied. The initial interface 120 may provide an “almost there” notification to the user 104, indicating that the package associated with the user 104 is nearing its delivery destination 112c. In this manner, the absence of an “almost there” notification may indicate to the user 104 that the package is not nearing the delivery destination 112c. In addition to an “almost there” notification, the example interface 120 may also present to the user 104 the option of selecting an alternative delivery destination. The example initial alternative delivery interface 120 provides example controls 122, 124 that the user 104 may select. In this implementation, the user may select control 122, “Yes, show me options,” to indicate that the user 104 wishes to be provided with alternative delivery options. Alternatively, the user 104 may select control 124, “No, deliver to destination,” to indicate that the user 104 wishes the package to be delivered to the package's original delivery destination 112c.

Upon selecting the “Yes, show me options” control 122, the user 104 is presented with a second alternative delivery interface 126, an example shown in FIG. 1C. The second interface 126 presents a candidate alternative delivery destination to the user 104. In other implementations, more than one candidate alternative delivery destination may be presented to the user 104. The example second interface 126 asks the user 104 if the user 104 wishes to meet the delivery agent 102 at a candidate alternative delivery destination within a given period of time. The given period of time may be a time duration, a time of day, a time duration relative to a time of day, and/or another time specification.

The candidate alternative delivery destinations may be at least partially based on the location of the delivery agent 102 and/or a location associated with the user 104, described below in more detail. By way of the interface 126, the user 104 may arrange to meet the delivery agent 102 at a particular candidate alternative delivery destination in order to receive the package at the location of that particular alternative delivery destination. In the example shown in FIG. 1C, the user 104 is presented with an alternative delivery destination “2 Main St,” corresponding to delivery destination 112b and stop 110b shown in FIG. 1A. The user 104 is also provided a control 128, “Yes, I'm on my way,” to indicate that the user 104 wishes to meet the delivery agent 102 at the specified alternative delivery destination within the specified time period. The user 104 is provided a control 130, “No, deliver to destination,” to indicate that the user 104 does not wish to meet the delivery agent 102 and instead wishes the package to be delivered to the original destination 112c. The user 104 may also be provided a control 132, “other options,” to indicate that the user 104 wishes to be provided with other options. The other options may include other candidate alternative delivery destinations, other meeting times, or other features.

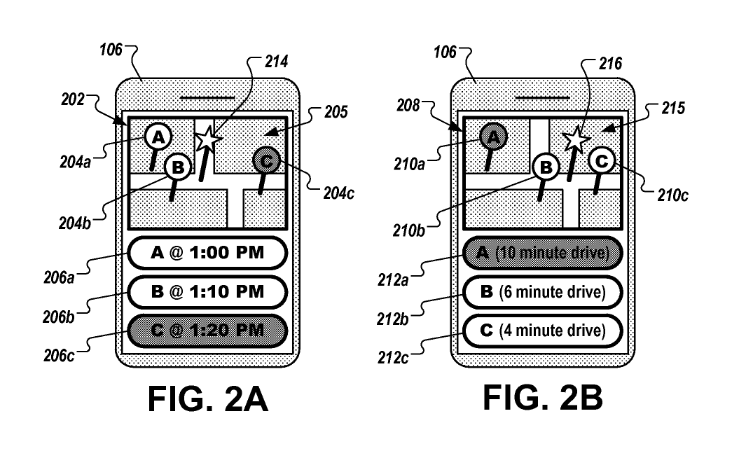

Turning to FIGS. 2A-B, FIGS. 2A-B show example interfaces 202, 208. The example interfaces 202, 208 may be included in or displayed in addition to interfaces 120, 126, 134. Example interface 202 in FIG. 2A displays multiple candidate alternative destinations 204a-c on a map 205. The alternative delivery destinations 204a-c may, for example, be stops on the delivery agent's route. The interface 202 also includes the user's current location 214 on the map 205. The interface 202 also includes example controls 206a-c corresponding respectively to the candidate alternative destinations 204a-c. The controls 206a-c also display, for each candidate alternative destination 204a-c, an approximate meeting time for the user to meet with the delivery agent at that destination. The user's location 214 is closer to the candidate destinations 204a-b, and candidate destination 204c is the farthest away from the user's location 214. The interface 202 displays the farthest candidate destination 204c and corresponding control 206c in a different color to indicate that it is the farthest from the user's location 214. In some cases, the interface 202 may deactivate control 206c to disallow selection of the farthest candidate destination 204c.

The example interface 208 in FIG. 2B displays multiple candidate alternative destinations 210a-c on a map 215. The interface 208 also includes the user's current location 216 on the map 215. The interface 208 also includes example controls 212a-c corresponding respectively to the candidate alternative destinations 210a-c. The controls 212a-c also display, for each candidate alternative destination 210a-c, an estimated user travel time for the user to meet with the delivery agent at that destination. The estimated user travel time to the candidate destination 204a is greater than the estimated user travel time to the candidate destinations 204b-c. The interface 208 displays the candidate destination 204a and corresponding control 212a in a different color to indicate that it is the farthest travel time from the user's location 214. In some cases, the interface 208 may deactivate control 212a to disallow selection of the candidate destination 210a. For example, the candidate destination 210a may be disallowed because the user would not be able to reach that location 210a in time to meet a delivery agent for package receipt.

Turning back to FIGS. 1A-E, upon selecting the “Yes, I'm on my way” control 128, the user 104 is presented with a third alternative delivery interface 134, an example shown in FIG. 1D. The third interface 134 presents a notification that the delivery agent 102 is expecting to meet the user 104 at the alternative delivery destination within the given period of time. The third interface 134 may also provide a countdown timer indicating a duration of time the delivery agent 102 is expected to remain at the alternative delivery destination. The third interface 134 may display other information, such as the location of the delivery agent 102, the estimated time for the delivery agent 102 to arrive at stop 110b designated as the alternative delivery destination, or other information or controls. For example, the third interface 134 may also include a control 136 to indicate that the user 104 wishes to cancel the alternative delivery and have the package delivered to the original destination 112c. The user 104 may also be provided a control 138, “other options,” to indicate that the user 104 wishes to be provided with other options.

FIG. 1E shows an example delivery agent interface 142 that can be provided to a computing device 140 used by the delivery agent 102. For example, the delivery agent interface 140 may be provided on a mobile device, laptop, tablet computer, music player, wearable computer, or other computing system available to the delivery agent 102. The delivery agent interface 142 may be provided to the delivery agent 102 upon the user 104 selecting the “Yes, I'm on my way” control 128. The example delivery agent interface 142 shows a notification indicating that the user 104 associated with stop 110c has requested to meet at stop 110b to pick up that user's package. The interface 142 also shows a notification indicating that the delivery agent 102 should wait at the stop 110b for a duration of time for the user 104 to pick up the package. The interface 142 may include a countdown timer, other notifications, and/or other controls. For example, the interface 142 may provide a control to increase or decrease the wait time, a control to propose a different meeting location to the user 104, a control to propose a different meeting time to the user 104, a control to notify the user 104 that the delivery agent 104 is early or late, a notification that the user 104 has cancelled the alternative destination request, and/or other features.

Upon the user 104 requesting an alternative delivery, the original stop 110c may be removed from the delivery route 108. The route 108 may also be changed to account for the removal of stop 110c, shown in FIG. 1A as route adjustment 116. For example, the route 108 may be planned to minimize distance traveled, minimize fuel consumption, minimize delivery times, or planned for other characteristics. In some cases, the route 108 planning may include an optimization of one or more characteristics.

Other implementations may use other interfaces, displays, and/or controls. In some implementations, the example first alternative delivery interface 120 and other interfaces 126, 134 are provided via an application or program running on the mobile device 106. In some implementations, the interfaces 120, 126, 134 are provided via text messages, Short Message Service (SMS) messages, or other messaging services. In some cases, the user 104 may receive alternative delivery notifications via such messages, and the user 104 may indicate decisions by sending appropriate messages. In some cases, one or more interfaces may activate to a default control or default indication after a predetermined period of inactivity. As an illustrative example, if a user does not respond to an inquiry within a certain period of time, for example selecting a candidate alternative delivery destination, the alternate delivery request may be cancelled.

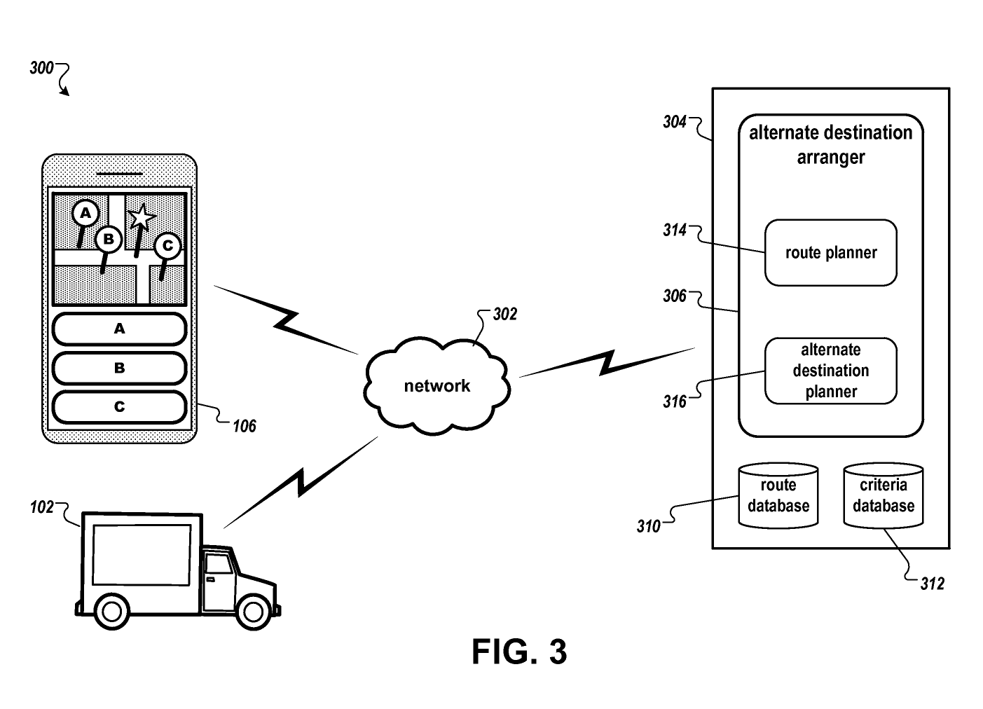

FIG. 3 is a block diagram of an example alternative delivery system 300. The alternative delivery system 300 may implement some or all of the alternative delivery system 100 shown in FIGS. 1A-E. The system 300 includes a server 304, a user mobile device 106, and a delivery agent 102. The server 304, mobile device 106, and delivery agent 102 are configured to communicate over a network 302. For example, the network 302 can be a wireless network, a cellular network, or another type of network.

The example server 304 includes a route database 310 and a criteria database 312. The route database 310 may store information associated with delivery routes. For example, the route database 310 may store current delivery routes, historical delivery routes, alternative delivery routes, the locations of historical delivery stops, locations of delivery agents, or other information associated with delivery routes. The criteria database 312 may store information associated with proximity criteria, such as the example proximity criteria described previously or other proximity criteria. The criteria database 312 may also store location information such as delivery agent locations, user locations, delivery stop locations, delivery destination locations, or other related information. For example, the criteria database 312 may store information associated with a particular user such as historical alternative deliveries for that user, including successful and missed alternative deliveries, historically selected alternative delivery destinations, user preferences, or other information. In some implementations, the route database 310 and the criteria database 312 are part of each other. In some implementations, the route database 310 and/or the criteria database 312 are part of another database or system.

The server 304 includes an alternative destination arranger 306. The alternative destination arranger 306 may determine alternative delivery destinations for a package. The alternative destination arranger 306 may receive information from and transmit information to the user's mobile device 106 and the delivery agent 102. For example, the alternative destination arranger 306 may receive an alternative delivery request from a user, determine one or more candidate alternative destinations, and transmit the candidate alternative destinations to the user. The alternative destination arranger 306 may also receive a selection of a particular alternative destination from a user. The alternative destination arranger 306 may communicate with the route database 310 and/or the criteria database 312.

The example alternative destination arranger 306 includes a route planner 314 and an alternative destination planner 316. In some implementations, the alternative destination planner 316 and the route planner 314 are the same component. In some implementations, the alternative destination planner 316 and/or the route planner 314 are part of another component. The alternative destination planner 306 may also include other components. The alternative destination planner 306 and its components may be models, modules, algorithms, or other systems.

The alternative destination planner 316 may determine one or more candidate alternative destinations. One or more of the candidate alternative destinations may be selected by a user. The candidate alternative destinations may be determined based on factors such as the location of the delivery agent, the location of the user, the location of the original delivery destination, the delivery route, locations of one or more delivery stops, traffic conditions, the current delivery schedule, delivery agent wait times, a number of unsuccessful historical meetings, or other factors. The alternative destination planner 316 may determine an alternative delivery destination for a package that minimizes a total wait time for all recipients on that route. The alternative destination planner 316 may determine an alternative delivery destination for a package based on historical alternative delivery data, for example historical data of the user's most selected alternative delivery destinations from previous deliveries.

The alternative destination planner 316 may determine an alternative delivery destination for a package that coincides with a delivery stop on the route associated with the delivery of that package. The alternative destination planner 316 may, for example, determine an alternative delivery destination that would minimize a distance or a travel time for the user and/or the delivery agent. For example, at the time the user indicates a wish for an alternative delivery destination, the user may be closer to a particular delivery destination on the route than all other delivery destinations on the route. In this case, the alternative destination planner 316 may determine the particular delivery destination to be a candidate alternative delivery destination. In some cases, the alternative destination planner 316 may determine an earlier delivery destination to be a candidate alternative delivery destination, and in some cases, the alternative destination planner 316 may determine a subsequent delivery destination to be a candidate alternative delivery destination. The earlier delivery destination may be, for example, a delivery destination that is reached by the delivery agent before the original delivery destination, and the subsequent delivery destination may be, for example, a delivery destination that is reached by the delivery agent after the original delivery destination. In some cases, it may be more convenient or take less overall time for a user to receive the package at an earlier or subsequent candidate delivery destination.

In some cases, the alternative destination planner 316 may determine a candidate alternative delivery destination that is not a predetermined delivery destination or a predetermined delivery stop. For example, the alternative destination planner 316 may determine a candidate alternative delivery destination that is between two predetermined stops on a delivery route. As another example, the candidate destination may be determined at a location that is not part of the delivery route. The alternative destination planner 316 may, for example, determine a candidate alternative delivery destination that minimizes potential or actual changes to the predetermined route.

The route planner 314 may determine a planned delivery route. The planned delivery route may be an updated delivery route or an optimized delivery route. For example, a particular delivery stop may be removed from a preexisting route, and the route planner 314 may determine a new alternative route excluding that particular delivery stop. The route planner 314 may, for example, alter the preexisting route to coincide with one or more alternative delivery destinations. The route planner 314 may determine an planned delivery route by minimizing alterations to the preexisting delivery route. The route planner 314 may, for example, determine a planned delivery route by minimizing a distance or a travel time of the delivery route. The route planner 314 may base the determination of delivery route on traffic conditions, delivery stop locations, alternative delivery locations, delivery agent wait times, or other factors.

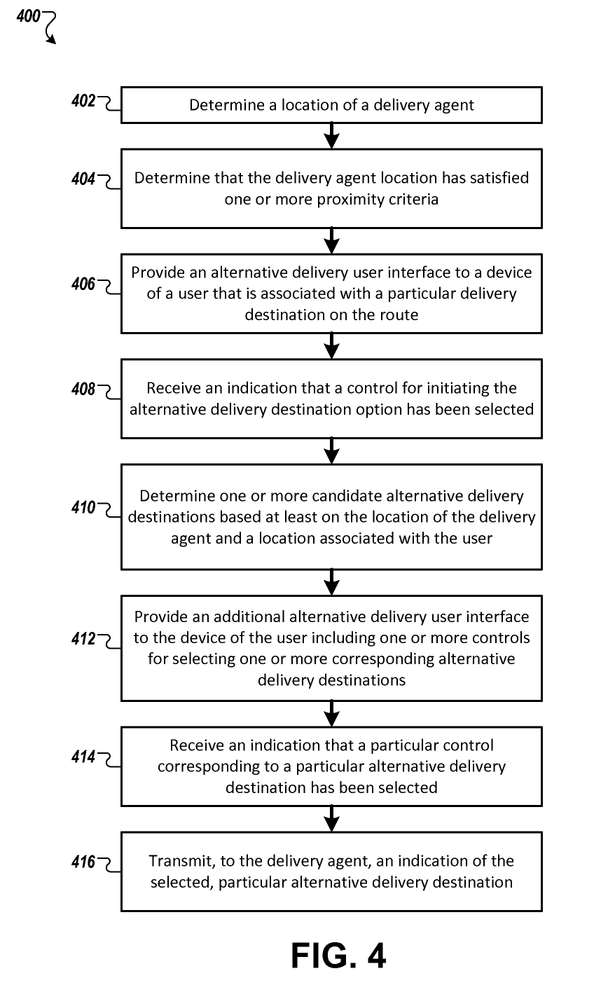

FIG. 4 is a flow chart illustrating an example process 400 for providing an alternative delivery destination. The example process 400 may be implemented, for example, by some or all of alternative delivery system 100 or alternative delivery system 200.

At 402, the location of a delivery agent is determined. The location of a delivery agent may be determined, for example, by one or more of a Global Positioning System (GPS), a service set identifier (SSID) of a nearby detected wireless network, a detected phone mast signal, a wireless media access control (MAC) address, or other system. At 404, the location of the delivery agent is determined to satisfy one or more proximity criteria. The proximity criteria can include some or all of the proximity criteria described previously, or other proximity criteria.

At 406, an alternative delivery interface is provided to a mobile device of a user. The user may be associated with a particular delivery destination on the delivery route of the delivery agent. The alternative delivery user interface may include a control for initiating an alternative delivery destination option. At 408, an indication is received that a control has been selected for initiating the alternative delivery destination option. For example, the indication may indicate that the user has selected the alternative delivery destination option on the alternative delivery interface provided to the mobile device.

At 410, one or more candidate alternative delivery destinations are determined. The candidate alternative delivery destinations may be based on the location of the delivery agent and a location associated with the user. For example, a candidate alternative delivery destination may be based on the location of the delivery agent as determined in 402, a current location of the delivery agent, a predicted location of the delivery agent, or another location associated with the delivery agent. The location associated with the user can be a determined location of the user, a predicted location associated with the user, a location of a delivery stop associated with the user, a delivery destination associated with the user, or another location associated with the user.

At 412, an additional alternative delivery user interface is provided to the device of the user. The additional alternative delivery user interface may include one or more controls for selecting one or more of the corresponding alternative delivery destinations. The alternative delivery destinations may be the candidate alternative delivery destinations determined at 410. At 414, an indication is received that a particular control has been selected corresponding to a particular alternative delivery destination. For example, the indication can indicate that the user has selected a particular alternative delivery destination on the alternative delivery interface provided to the mobile device.

At 416, the indication of the selected particular alternative destination is transmitted to the delivery agent. The indication can include, for example, some or all of the location of the selected particular alternative destination, a location of the user, a meeting time, a wait time, a delivery route change, or other information.

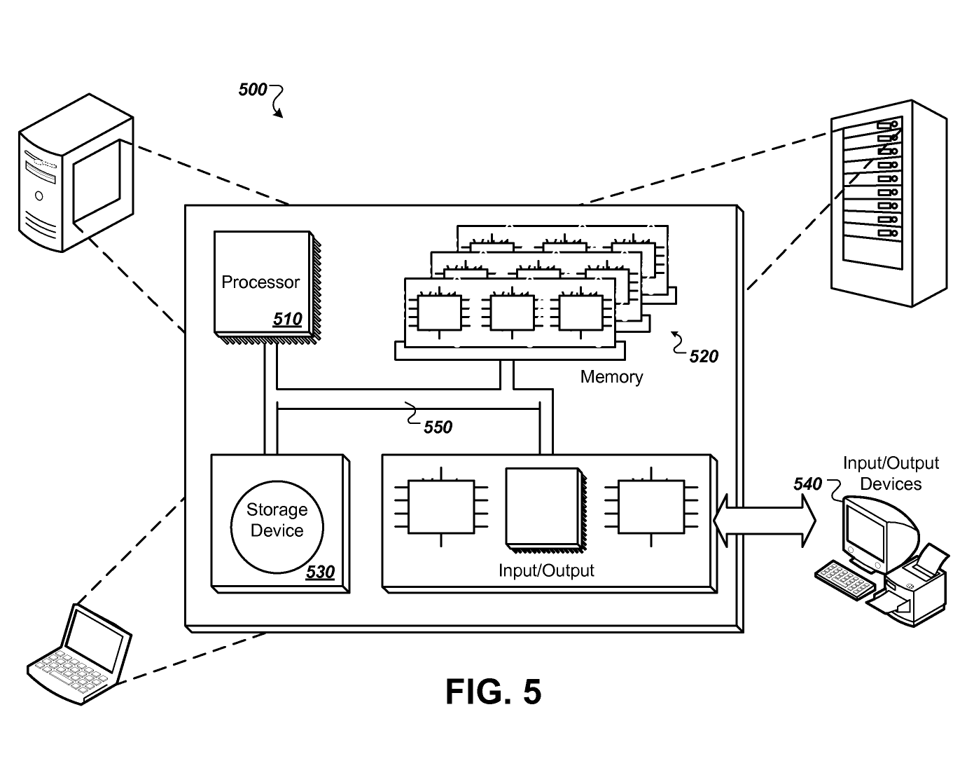

FIG. 5 illustrates a schematic diagram of an exemplary generic computer system. The system 500 can be used for the operations described in association with the alternative delivery systems 100, 200 and the process 400 according to some implementations. The system 500 may be included in the system 100 and/or the system 200.

The system 500 includes a processor 510, a memory 520, a storage device 530, and an input/output device 540. Each of the components 510, 520, 530, and 540 are interconnected using a system bus 550. The processor 510 is capable of processing instructions for execution within the system 500. In one implementation, the processor 510 is a single-threaded processor. In another implementation, the processor 510 is a multi-threaded processor. The processor 510 is capable of processing instructions stored in the memory 520 or on the storage device 530 to display graphical information for a user interface on the input/output device 540.

The memory 520 stores information within the system 500. In one implementation, the memory 520 is a computer-readable medium. In one implementation, the memory 520 is a volatile memory unit. In another implementation, the memory 520 is a non-volatile memory unit.

The storage device 530 is capable of providing mass storage for the system 500. In one implementation, the storage device 230 is a computer-readable medium. In various different implementations, the storage device 530 may be a floppy disk device, a hard disk device, an optical disk device, or a tape device.

The input/output device 540 provides input/output operations for the system 500. In one implementation, the input/output device 540 includes a keyboard and/or pointing device. In another implementation, the input/output device 540 includes a display unit for displaying graphical user interfaces.

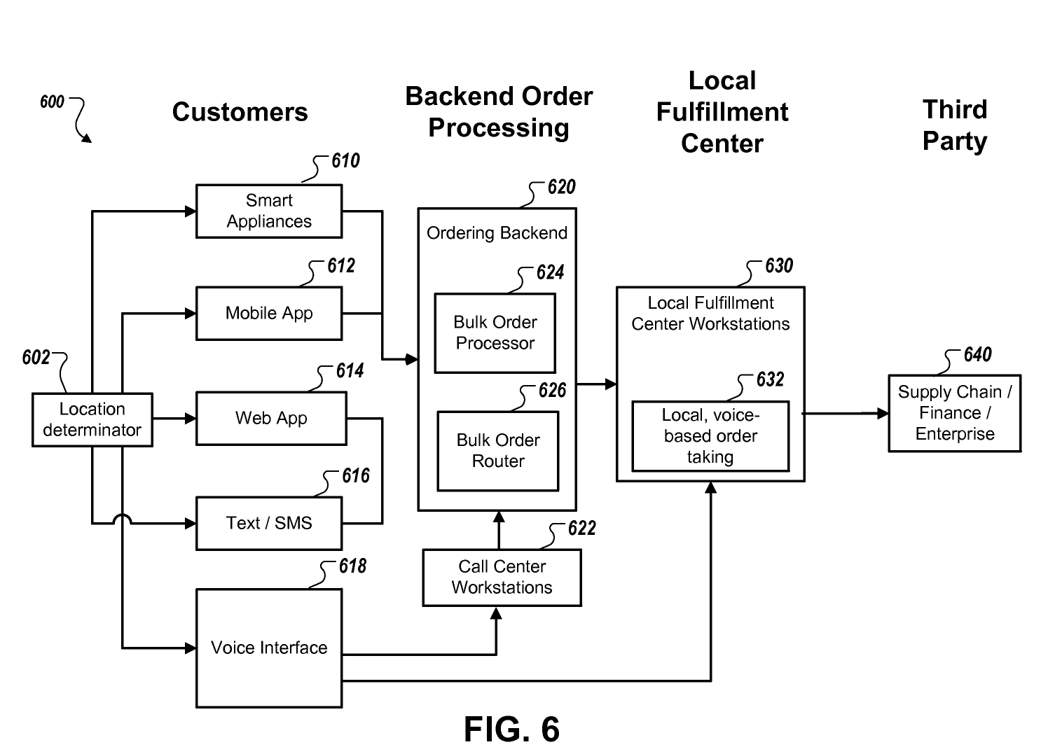

FIG. 6 is a block diagram of an example delivery system 600. Briefly, and as described in further detail below, the system 600 may include a location determinator 602, smart appliances 610, a mobile application 612, a web application 614, a text or short message service (SMS) application 616, a voice interface 618, an ordering backend 620, call center workstations 622, local fulfillment center workstations 630, and a supply chain, finance, or enterprise component 640. The system 600 may provide for real time delivery of an item. Real time delivery may include point-to-point delivery of small, tangible, purchased goods within a very short period of time of purchase, e.g., few minutes to a few hours. Purchased goods may include typical packaged goods that do not otherwise require real-time delivery, e.g., consumer electronics or office supplies, goods that degrade over a long period of time, e.g., groceries or flowers, or goods that degrade within a very short period of time, e.g., dry ice, ice cream, hot pizza or a cup of coffee.

The location determinator 602 may determine location information for a customer. For example, the location determinator 602 may determine a customer's location based on or more of a service set identifier (SSID) of a nearby detected wireless network, a detected phone mast signal, determined global positioning system (GPS) information, an assigned Internet Protocol (IP) address, a landline location, or a wireless media access control (MAC) address. The location determinator 602 may provide the location information to the smart appliances 610, the mobile application 612, the web application 614, the text or short message service (SMS) application 616, and the voice interface 618.

The smart appliances 610, the mobile application 612, the web application 614, the text or short message service (SMS) application 616, and the voice interface 618 may enable a customer to place an order. For example, one or more of the smart appliances 610, the mobile application 612, the web application 614, the text or short message service (SMS) application 616, and the voice interface 618 may enable a customer to place an order for an item to be delivered to the customer's home address at 6:00 PM. To enable customers to place orders, the smart appliances 610, the mobile application 612, the web application 614, the text or short message service (SMS) application 616, and the voice interface 618 may provide interfaces through which the customer may specify a particular item to order, and a particular location for which the customer would like to obtain the item. For example, the smart appliances 610, the mobile application 612, the web application 614, the text or short message service (SMS) application 616, and the voice interface 618 may visually or audibly provide prompts to the customer requesting that the customer specify a particular item to order, a particular location to receive the item, and a particular time to receive the item.

More specifically, the smart appliances 610 may be appliances that may be used to place orders. For example, the smart appliances 610 may include a television that may be used by a customer to place an order for an item. The smart appliances 610 may provide an interface for a customer to place an order. For example, the smart appliance 610 may include a display that may render an interface for the customer to order an item. The smart appliances 610 may provide orders to an ordering backend 620. For example, the smart appliances 610 may provide an order for an item through a network to the ordering backend 620.

The mobile application 612 may be an application running on a mobile device that enables a customer to place an order. For example, an application running on a customer's smart phone may enable the customer to place an order for an item. A mobile device may include a smart phone, a tablet computer, or some other type of computing device that may be portably used. The mobile application 612 may provide an interface for a customer to place an order. For example, the mobile application 612 may display on the mobile device an interface for the customer to order an item. The mobile application 612 may provide orders to an ordering backend 620. For example, the mobile application 612 may provide an order for an item through a network to the ordering backend 620.

The web application 614 may be an application accessible through a web browser running on a computing device, where the application enables a customer to place an order. For example, a Java application may be rendered by a web browser on a desktop computer and enable a customer to place an order for an item. A computing device may include a mobile device, a desktop computer, a laptop computer, or some other type of device that computes. The web application 614 may provide an interface for a customer to place an order. For example, the web application 614 may display an interface, in a web browser on a desktop computer, for the customer to order an item. The web application 614 may provide orders to an ordering backend 620. For example, the web application 614 may provide an order for an item through a network to the ordering backend 620.

The text or SMS application 616 may be an application running on a mobile device that enables a customer to place an order by text or SMS. For example, an application running on a customer's smart phone may enable the customer to send a text or SMS message to the ordering backend 620 to place an order for package. In some implementations, the application may provide a graphical user interface for the user to select a particular item, particular location, and a particular time to receive the item, and generate a SMS message indicating the selections and provide the SMS message to the ordering backend 620.

The voice interface 618 may be an interface that enables a customer to place an order by voice. For example, the voice interface 618 may be a telephone that a customer may use to verbally order an item. The voice interface 618 may communicate with the call center workstations 622. For example, the voice interface 618 may transmit audio captured by the voice interface 618 to the call center workstations 622, and similarly, output audio from the call center workstations 622. The voice interface 618 may additionally or alternatively communicate with a local voice-based order taking component 632 of a local fulfillment center workstation 630. For example, the voice interface 618 may transmit audio captured by the voice interface 618 to the local voice-based order taking component 632, and similarly, output received audio from the local voice-based order taking component 632.

The call center workstations 622 may receive voice input from the voice interface 618, generate orders based on the voice input, and provide the orders to the ordering backend 620. For example, the call center workstations 622 may audibly output voice input from the interface 618 to allow customer service representatives to verbally interact with customers, and generate orders for the customers. In some implementations, the call center workstations 622 may be automated and use speech recognition to generate orders for users. For example, the call center workstations 622 may execute an Artificial Intelligence customer service agent program that may verbally speak to the customer to take the order and place the order directly for the customer.

The ordering backend 620 may be a component that processes orders from customers. For example, the ordering backend may receive orders from the smart appliances 610, mobile application 612, web application 614, text or SMS application 616, the voice interface 618, or the call center workstations 622. The ordering backend 620 may process orders based on determining, for each order, one or more local fulfillment center workstations 630 to receive the order. For example, the ordering backend 620 may determine that a first order for an item should be provided to a first local fulfillment center workstation and a second order for an item should be provided to a different, second local fulfillment center workstation.

The ordering backend 620 may determine a local fulfillment center workstation to receive a particular order based on a location which the customer would like to obtain the item ordered. For example, the ordering backend 620 may determine that a first order indicates the order is to be obtained at a location where the distance from the location to the local fulfillment center is within a distance threshold, and in response, determine to provide the first order to a workstation of the local fulfillment center. In another example, the ordering backend 620 may determine that a second order is to be obtained at a location where the distance from the location to the local fulfillment center exceeds a distance threshold, and in response, determine the second order should be provided to a workstation of another local fulfillment center.

Additionally or alternatively, the ordering backend 620 may determine a local fulfillment center workstation to receive a particular order based on availability of the local fulfillment center to fulfill the order. For example, the ordering backend 620 may determine that a first order for an item can be fulfilled by a local fulfillment center as the local fulfillment center may still have capacity to provide the item. In another example, the ordering backend 620 may determine that a second order for an item cannot be fulfilled by a local fulfillment center as the local fulfillment center may not have capacity to provide the item.

In response to determining the local fulfillment center workstations 630 to receive an order, the ordering backend 620 may provide the order to the local fulfillment center workstations 630. For example, in response to determining that a local fulfillment center does deliver to the particular location requested by a customer and has capacity to fulfill an order for an item, the ordering backend 620 may determine to provide the order for the item to the local fulfillment center workstations 630 of the local fulfillment center.

In processing the orders, the ordering backend may also process payments for the orders. For example, the ordering backend 620 may validate whether payment information provided in the order is correct. In another example, the ordering backend 620 may place charges for orders using payment information provided in the order.

The ordering backend 620 may include a bulk order processor 624. The bulk order processor 624 may enable the ordering backend 620 to perform mass processing of orders. For example, the ordering backend 620 may receive an extremely large number of orders within a given time frame from the smart appliances 610, mobile application 612, web application 614, text or SMS application 616, the voice interface 618, or the call center workstations 622. Processing such an amount of orders may include determining, for each order, one or more local fulfillment center workstations out of thousands of potential local fulfillment center workstations 630 to receive the order.

The ordering backend 620 may also include a bulk order router 626. The bulk order router 626 may enable the ordering backend 620 to perform mass management of logistics, including delivery scheduling and collection scheduling of received orders. For example, the ordering backend may receive an extremely large number of orders within a given time frame from the smart appliances 610, mobile application 612, web application 614, text or SMS application 616, the voice interface 618, or the call center workstations 622. Managing the delivery scheduling or collection scheduling of such an amount of orders may include determining an order preparation schedule for each local fulfillment center workstation.

The ordering backend 620 performs a variety of tasks relating to processing or routing bulk orders, including sorting, assigning, routing, queuing, distributing and scheduling, to name a few. The study, optimization and execution of these tasks requires the uses of techniques and results from well-developed, active areas of scientific research, such as operational research, combinatorial optimization, graph theory (in particular network theory), queuing theory, and transport theory. Executing or providing optimal solutions to such tasks are proven to be complex and mathematically hard, particularly when considering large-scale systems. For example, e-commerce giant Amazon reported that they received, processed and delivered orders for 426 items per second in the run up to Christmas in 2013, see for example http://articles.latimes.com/2013/dec/26/business/la-fi-tn-amazon-sold-426-items-per-second-cyber-monday-20136226.

Since scaling is an extremely important factor, particularly in the context of e-commerce, tasks relating to processing or routing bulk orders quickly become extremely difficult, if not impossible, to solve and require powerful computers implementing complex algorithms and elegant mathematical programming techniques, as well as robust hardware architectures that can be parallelized. In some cases, it has even been shown that many tasks relating to the processing or routing of bulk orders are computationally intractable. In fact, the theory of computational complexity has introduced a concept of NP-hardness to classify such computationally intractable tasks.

For example, consider the intensely studied Traveling Salesman Problem (TSP), an NP-hard problem in combinatorial optimization. In its purest formulation, the TSP may be described as follows: given a list of cities and the distances between each pair of cities, what is the shortest route that visits each city exactly once, and returns to the original city. The TSP may also be modeled and described as a graph problem, wherein the cities are the graph's vertices and the distances between each pair of cities are the lengths of the graph's edges, or formulated as an integer linear program. The TSP has several applications in operational research, including planning and logistics, wherein the concept of a city may represent customers or orders, and the concept of a distance may represent travelling times or incurred costs. In some implementations, additional constraints may be imposed on the TSP, such as limiting an amount of resources or limiting to certain time windows. Finding increasingly efficient solutions to the TSP and other such complex, subtle operational research problems is an active area of scientific research, as evidenced by a plethora of technical textbooks, journals and scientific articles. See, for example “In Pursuit of the Travelling Salesman: Mathematics at the Limits of Computation,” William Cook, Princeton University Press, 2011, “Dynamic programming strategies and reduction techniques for the traveling salesman problem with time windows and precedence constraints,” L. Bianco, A. Mingozzi, and S. Ricciardelli, Operations Research, 45 (1997) 365-377 and “Scheduling vehicles from a central depot to a number of delivery points,” G. Clarke and J. Wright, Operations Research 12 (1964) 568-581.

Another well-studied, fundamental combinatorial optimization problem in the field of operational research and optimization is the Assignment Problem (AP). In its most general form, the AP may be described as follows: given a number of agents, a number of tasks and a set of incurring costs for each potential agent-task assignment, perform all tasks by assigning one agent to each task, and one task to each agent, such that the total costs incurred is minimized. The AP also has several applications in areas such as planning and logistics. For example, the ordering backend 620 may interpret the task of processing received orders as an assignment problem, wherein a local fulfillment center workstation can be assigned to deliver an order, incurring some cost. The bulk order processor 624, for example, may require that all orders are delivered by assigning one local fulfillment center to each order, and one order to each local fulfillment center, in such a way that the total cost of the assignment is minimized. It has been shown that such an assignment problem can be expressed mathematically as a standard linear program, see, for example “Algorithms for the Assignment and Transportation Problems,” James Munkres, Journal of the Society for Industrial and Applied Mathematics Vol. 5, No. 1 (March, 1957), pp. 32-38.

Linear programming has been shown to be an extremely powerful, essential optimization technique widely applied in various fields of study such as business studies and economics, as well as industrial areas such as engineering, transportation and manufacturing. The sophisticated mathematical programming techniques used in linear programming have proven essential to the modeling of diverse types of problems in routing, scheduling and assignment, and in turn have led to the creation of powerful computer systems that enable businesses to reduce costs, improve profitability, use resources effectively, reduce risks and provide untold benefits in many other key dimensions. Mathematically, linear programming is a technique for the optimization of a linear objective function, subject to linear equality and linear inequality constraints. While this requirement may seem overly restrictive, many real-world business problems can be formulated in this manner. Today, commercial linear-programming codes are able to solve linear programs with millions of constraints. For example, the commercial, high-performance mathematical programming solver IBM ILOG CPLEX of IBM is able to solve linear programs with the number of megabytes required for computation approximately equal to the number of constraints divided by 1000, see http://www-01.ibm.com/support/docview.wss?uid=swg21399933.

When dealing with large-scale systems, system components, such as the ordering backend 620, may employ techniques and results from Queuing Theory—the mathematical study of waiting lines, or queues—in order to model incoming customers or orders and subsequently make business decisions relating to order fulfillment, resource requirements for providing a certain service, expected waiting time in a queue, average time in a queue, expected queue length, expected number of customers in a queue at a given time, and the probability of a system to be in a certain state, such as empty or full. For example, it has been shown that most queues in restaurant operations can be described by an M/M/1 queue, where arrivals are determined by a Poisson process with heavy periods around lunch and dinner time, and service times have an exponential distribution. In a complex system of multiple M/M/1 queues, or a queue network, deep and sophisticated mathematical techniques such as stochastic calculus may be employed to model or approximate the queuing process. For example, in some implementations a heavy traffic approximation may be used to approximate a queuing process by a reflected Brownian motion, Ornstein-Uhlenbeck process or more general diffusion process. Since queues are basic components to both external and internal business processes, including scheduling and inventory management, understanding the nature of queues and learning how to manage them is one of the most important areas in operational research and management. See, for example, “A Methodology and Implementation for Analytic Modeling in Electronic Commerce Applications,” H. Edwards, M. Bauer, H. Lutfiyya, Y. Chan, M. Shields and P. Woo, Electronic Commerce Technologies, Lecture notes in computer science, Volume 2040, 2001, pp 148-157 and “Stochastic Models in Queuing Theory”, J. Medhi, Elsevier Academic Press, 2002.

The local fulfillment center workstations 630 may receive orders from the ordering backend 620. For example, a particular local fulfillment center workstation may receive an order for an item from the ordering backend 620. The local fulfillment center workstations may be located on the premises of the local fulfillment center and used by agents of the local fulfillment center. For example, a local fulfillment center workstation of a pizza provider may be located in a kitchen of the pizza provider and used by bakers to determine what pizzas to bake and when to bake the pizzas. In another example, local fulfillment center workstations of a pizza provider may be located in delivery vehicles of the pizza provider and used by pizza deliverers to determine where to deliver each pizza or a delivery route for the pizzas. The delivery route may be dynamically planned based on types of orders and locations to which the orders will be delivered. In yet another example, a local fulfillment center workstation may be used by a cashier of a pizza provider and used by the cashier to place additional orders for customers within the restaurant or determine whether a customer is the correct customer to receive a pizza that is ordered for pickup at the restaurant.

The local fulfillment center workstations 630 may provide information to agents of the local fulfillment center to fulfill orders. For example, a particular local fulfillment center workstation of an item provider may display an order number, a type of item ordered, a customer name for the order, a place of delivery for the order, and a time of delivery for the order. The local fulfillment center workstations 630 may obtain the information to provide agents of the local fulfillment center from the orders received from the ordering backend 620. For example, the orders received from the ordering backend 620 may include data that indicates an order number, a type of item ordered, a customer name for the order, a place of delivery for the order, and a time of delivery for the order. In some implementations, the local fulfillment center workstations 630 may prioritize the fulfillment of orders. For example, the local fulfillment center workstations 630 may prioritize the fulfillment of orders based on when the orders are to be provided to the users.

The local fulfillment center workstations 630 may include a local, voice-based order taking component 632. For example, the local fulfillment center workstations 630 may include a telephone-based system with which an employee of the local fulfillment center may speak to the customer. The local, voice-based order taking component 632 may enable customers to place orders directly with the local fulfillment center. For example, the same local fulfillment center workstations 630 that receive orders from the ordering backend 620 may also be used to generate orders based on input from customer service agents using the local fulfillment center workstations 630. In some implementations, the local, voice-based order taking component 632 may be automated and use speech recognition to generate orders for users.

The local fulfillment center workstations 630 may additionally or alternatively communicate with a supply chain or finance or enterprise component of a third party. For example, a local fulfillment center workstation may place an order for more flour with a supply chain component of a third party that sells flour for pizza. In another example, a local fulfillment center workstation may communicate with a finance component to place payment charges for orders.

The local fulfillment center workstations 630 may automatically determine to communicate with the supply chain or finance or enterprise component. For example, the local fulfillment center workstations 630 may automatically determine that the amount of flour in the inventory of the local fulfillment center is below a flour threshold, and in response, place an order for flour to the supply chain component of a pizza flour provider.

Embodiments of the subject matter, the functional operations and the processes described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible nonvolatile program carrier for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “data processing apparatus” encompasses all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a standalone program or as a module, component, subroutine, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Computers suitable for the execution of a computer program include, by way of example, can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

What is claimed is:

1. A computer-implemented method comprising:
determining a location of a delivery agent that is associated with a delivery route having one or more delivery destinations;
determining that the location has satisfied one or more proximity criteria;
in response to determining that the location has satisfied the one or more proximity criteria, providing an initial alternative delivery user interface to a device of a user that is associated with a particular delivery destination on the route, wherein the alternative delivery user interface includes a control for initiating an alternative delivery destination option;
receiving an indication that the control for initiating the alternative delivery destination option has been selected;
determining one or more candidate alternative delivery destinations based at least on the location of the delivery agent and a location associated with the user;
providing an additional alternative delivery user interface to the device of the user, wherein the additional alternative delivery user interface includes one or more controls for selecting one or more corresponding alternative delivery destinations;
receiving an indication that a particular control corresponding to a particular alternative delivery destination has been selected; and
in response to receiving an indication that a particular control corresponding to a particular alternative delivery destination has been selected, transmitting, to the delivery agent, an indication of the selected, particular alternative delivery destination.

2. The method of claim 1, the proximity criteria comprises one or more of a proximity to the user, a proximity to a delivery destination, a proximity to a delivery route, a location within a designated geographic region, an estimated travel time associated with the user, and an estimated travel time associated with the delivery agent.

3. The method of claim 1, further comprising in response to receiving an indication that a particular control corresponding to a particular alternative delivery destination has been selected, determining an updated delivery route.

4. The method of claim 3, further comprising transmitting, to the delivery agent, the updated delivery route.

5. The method of claim 3, wherein determining an updated delivery route comprises excluding the particular delivery destination from the delivery route.

6. The method of claim 1, further comprising in response to receiving an indication that a particular control corresponding to a particular alternative delivery destination has been selected, determining a delivery agent wait time associated with the particular alternative delivery destination.

7. A system comprising:
one or more computers and one or more storage devices storing instructions that are operable, when executed by the one or more computers, to cause the one or more computers to perform operations comprising:
determining a location of a delivery agent that is associated with a delivery route having one or more delivery destinations;
determining that the location has satisfied one or more proximity criteria;
in response to determining that the location has satisfied the one or more proximity criteria, providing an initial alternative delivery user interface to a device of a user that is associated with a particular delivery destination on the route, wherein the alternative delivery user interface includes a control for initiating an alternative delivery destination option;
receiving an indication that the control for initiating the alternative delivery destination option has been selected;
determining one or more candidate alternative delivery destinations based at least on the location of the delivery agent and a location associated with the user;
providing an additional alternative delivery user interface to the device of the user, wherein the additional alternative delivery user interface includes one or more controls for selecting one or more corresponding alternative delivery destinations;
receiving an indication that a particular control corresponding to a particular alternative delivery destination has been selected; and
in response to receiving an indication that a particular control corresponding to a particular alternative delivery destination has been selected, transmitting, to the delivery agent, an indication of the selected, particular alternative delivery destination.

8. The system of claim 7, the proximity criteria comprises one or more of a proximity to the user, a proximity to a delivery destination, a proximity to a delivery route, a location within a designated geographic region, an estimated travel time associated with the user, and an estimated travel time associated with the delivery agent.

9. The system of claim 7, further comprising in response to receiving an indication that a particular control corresponding to a particular alternative delivery destination has been selected, determining an updated delivery route.

10. The system of claim 9, further comprising transmitting, to the delivery agent, the updated delivery route.

11. The system of claim 9, wherein determining an updated delivery route comprises excluding the particular delivery destination from the delivery route.

12. The system of claim 7, further comprising in response to receiving an indication that a particular control corresponding to a particular alternative delivery destination has been selected, determining a delivery agent wait time associated with the particular alternative delivery destination.

13. A computer-readable medium storing software comprising instructions executable by one or more computers which, upon such execution, cause the one or more computers to perform operations comprising:
determining a location of a delivery agent that is associated with a delivery route having one or more delivery destinations;
determining that the location has satisfied one or more proximity criteria;
in response to determining that the location has satisfied the one or more proximity criteria, providing an initial alternative delivery user interface to a device of a user that is associated with a particular delivery destination on the route, wherein the alternative delivery user interface includes a control for initiating an alternative delivery destination option;
receiving an indication that the control for initiating the alternative delivery destination option has been selected;
determining one or more candidate alternative delivery destinations based at least on the location of the delivery agent and a location associated with the user;
providing an additional alternative delivery user interface to the device of the user, wherein the additional alternative delivery user interface includes one or more controls for selecting one or more corresponding alternative delivery destinations;
receiving an indication that a particular control corresponding to a particular alternative delivery destination has been selected; and
in response to receiving an indication that a particular control corresponding to a particular alternative delivery destination has been selected, transmitting, to the delivery agent, an indication of the selected, particular alternative delivery destination.

14. The system of claim 12, the proximity criteria comprises one or more of a proximity to the user, a proximity to a delivery destination, a proximity to a delivery route, a location within a designated geographic region, an estimated travel time associated with the user, and an estimated travel time associated with the delivery agent.

15. The system of claim 12, further comprising in response to receiving an indication that a particular control corresponding to a particular alternative delivery destination has been selected, determining an updated delivery route.

16. The system of claim 15, further comprising transmitting, to the delivery agent, the updated delivery route.

17. The system of claim 15, wherein determining an updated delivery route comprises excluding the particular delivery destination from the delivery route.

18. The system of claim 12, further comprising in response to receiving an indication that a particular control corresponding to a particular alternative delivery destination has been selected, determining a delivery agent wait time associated with the particular alternative delivery destination.
